(19) United States
(12) Patent Application Publication
(10) Pub. No.: US 2011/0314103 A1
(43) Pub. Date: Dec. 22, 2011

(54) SYNCHRONIZED PROCESSES COMMUNICATING OVER A WIDE AREA NETWORK AND METHOD

(76) Inventors: Georges Harik, Palo Alto, CA (US); Varuna Jayasiri, Maharagama (LK); Thomas Flanagan, Palo Alto, CA (US); Octavian Daniel Dumitran, East Palo Alto, CA (US)

(21) Appl. No.: 13/162,264

(22) Filed: Jun. 16, 2011

Related U.S. Application Data
(60) Provisional application No. 61/356,418, filed on Jun. 18, 2010.

(51) Int. Cl. G06F 15/16

(52) U.S. Cl. 709/205

(57) ABSTRACT

Communicating peer processes on a wide area network may be synchronized in real time using a client-side library in conjunction with a centralized communication service. Such an approach provides a considerably easier way to develop applications as diverse as multiplayer games, synchronized video watching, document collaboration systems, and a range of web applications that require communication between multiple web clients.

### CROSS REFERENCE TO RELATED APPLICATIONS

The present application is related to and claims priority of U.S. provisional patent application (“Provisional Patent Application’), entitled ‘Synchronized Processes Communicating Over a Wide Area Network and Method,” Ser. No. 61/356,418, filed on Jun. 18, 2010. The Provisional Patent Application is hereby incorporated by reference herein in its entirety.

### BACKGROUND OF THE INVENTION

1. Field of the Invention

The present invention relates to synchronizing processes running on computers on a wide area network. In particular, the present invention relates to a method for synchronizing peer processes on multiple processors in real-time under control of a uniform user interface running on each computer.

2. Discussion of the Related Art

Web applications that require real-time communication between two or more web clients are difficult to develop. The difficulties concern: 1) message routing between clients, 2) techniques for receiving messages over the web, and 3) maintaining a consistent shared state. Typically, message routing between web clients require setting up a server. Receiving messages over the web in such synchronized web processes are complicated and arcane due to required techniques such as long polling, flash streaming or other so-called COMET techniques. Maintaining a consistent shared state among the web processes is difficult without either a web server or using such complicated protocols.

### SUMMARY OF THE INVENTION

According to one embodiment of the present invention, communicating peer processes on a wide area network may be synchronized in real time using a client-side library, in conjunction with a centralized service providing a virtual channel. The present invention provides a considerably easier way to develop Internet applications as diverse as multiplayer games, synchronized video watching, document collaboration systems, and a range of web applications that require communication between multiple web clients. The present invention is applicable to any system that connects to the internet. For example, libraries within the scope of the present invention may be created for mobile devices and game consoles.

To allow client-side programs of a multi-user application program to interact using an independent communication service, a method includes (a) providing a library of programs to be included in each of the client programs, the library of programs allowing the client programs to interact with each other through the communication service, using a communication protocol over a wide area network, and (b) providing a communication handler that receives service requests from each client program through the corresponding library of programs executing on a client processor, the communication handler interacting with each client program to provided the requested service using the communication protocol.

The present invention is better understood upon consideration of detailed description below,

### BRIEF DESCRIPTION OF THE DRAWINGS

FIG. 1 illustrates the operation of one application, according to one embodiment of the present invention.

FIG. 2 shows a model of the communication among the client programs and the virtual channel, according to one embodiment of the present invention.

### DETAILED DESCRIPTION OF THE PREFERRED EMBODIMENTS

According to one embodiment of the present invention, communicating peer processes on a wide area network may be synchronized in real time using a client-side library, in conjunction with a centralized service. In such an embodiment, the client-side library abstracts messages that are sent and received over a virtual channel. The virtual channel may be created by the centralized service as a result of a service request from a utility program in the library of any of the client programs. The name of the virtual channel may then be communicated to the other client programs which are expected to exchange information over the virtual channel. Using utility programs in their respective client-side libraries, these other client programs may subscribe to the virtual channel. The centralized service resides in a server as a server-side library and includes a message handler which acts primarily as a message router among the client programs and an arbiter and maintainer of a shared state among the client programs.

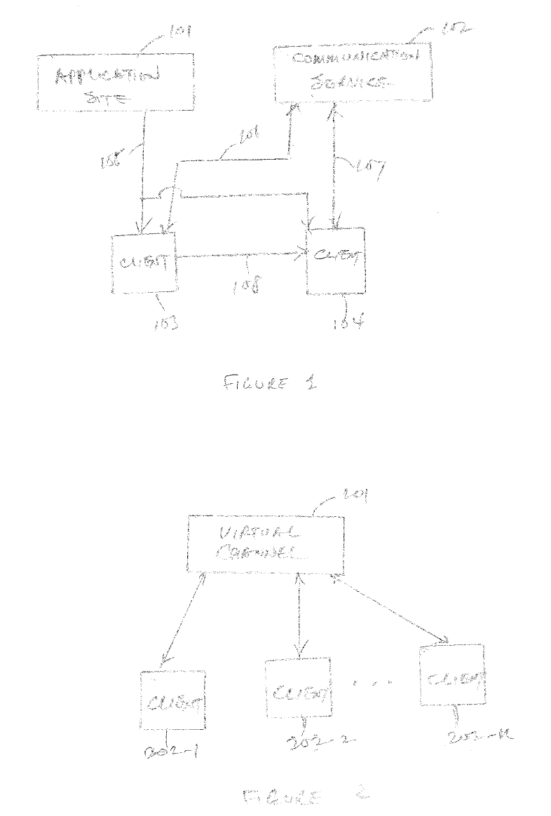

FIG. 1 illustrates the operation of one application, according to one embodiment of the present invention. As shown in FIG. 1, an application developer of a multi-user application program (e.g., a multi-player game) (e.g., a game developer) may provide website 101, which is to be accessed by potential users of the multi-user application program. In the prior art, such a developer would create a customized communication module for handling communication among the users. In this embodiment, the application developer includes instead a library of utility programs for connecting and interacting with communication service 102. In this embodiment, the library of utility programs is specific to communication service 102, rather than being specific to the application developer. For a web application, the utility programs in the library may be written, for example, in Javascript or a similar scripting language, to allow execution as plug-in programs by a web browser. The library is accessed through the library's application program interface (API) which exposes the communication functions that the application developer cam use to provide communication services to its users, rather than providing the proprietary communication module. In this manner, application developers are relieved of the burden of developing their own customized communication modules.

In this embodiment, to use the application program, each user downloads (step 105) a copy of the application program from website 101 to be run on client-side, together with the included library. These downloaded client application programs are represented in FIG. 1 by client programs 103 and 104. When the multi-user application program is launched, each client program connects to communication service 102 using, for example, the hyper-text transport protocol (HTTP). These connections are represented in FIG. 1 by connections 106 and 107. One of the client programs (e.g., client program 103) makes a request to communication service 102 (“the server”) over its connection to create a “virtual channel.” The virtual channel is a communication object that includes a server-side portion that is managed by the server for interacting with a set of client programs. The virtual channel is identified by a “channel name” which is a name either agreed upon by the users of the multi-user application program, or communicated (step 108) to each user by the user who initiated the virtual channel. Upon creation of the virtual channel, other client programs may connect or subscribe to the virtual channel by the channel name. Each client program may send messages to the channel, each of which is then provided by the server to all the other subscribing clients, except when the message is sent by the sending client specifically designating a particular client. Messages may be provided as an object expressed in a standard data-exchange format (e.g., a javascript object notation or JSON). In this manner, messages need not be textual. Various structured data, e.g., video, may be sent as a message using this mechanism.

Messages delivered according to the present invention may be delivered in a ‘reliable” manner. Reliable messages from a sending client program are guaranteed by the communication protocol to be delivered to each receiving client program in the order that the messages are sent. In one implementation, the messages from each client program is tracked by a sequence number. Delivery is ascertained by each receiving client program acknowledging receipt of each message. The server retransmits any message sent in a reliable manner if an acknowledgement is not received from the receiving client program after a pre-determined time. As messages sent out by different client programs are asynchronous, the server may send out the messages received in the order they are received. In one embodiment, the server attaches a timestamp to each message received to allow each client program to order locally messages it receives. Reliable message delivery may be realized by providing in the server, for each client program in the virtual channel, and on the client program side, incoming and outgoing message queues.

FIG. 2 shows a model of the communication among the client programs and the virtual channel. according to one embodiment of the present invention. As shown in FIG. 2, each subscribing client program sends messages into the virtual channel and receives from the virtual channel messages it is allowed to receive.

In one embodiment, the client-side library makes it easy to communicate with the centralized service using a combination of streaming, long polling, web sockets or flash, or any other technique that is supported in a web client program. The library detects client specifications and chooses an efficient method to communicate with the centralized service. Through such a client-side library, the client program can create, subscribe to, or publish to one or more virtual channels. According to one embodiment of the present invention, the client-side library has an API which exposes the following functions:
Channel (callback, [id])
   (a) creates a virtual channel instance that is to be referred to by the “id” parameter, if the virtual channel instance does not already exists; otherwise, creates a connection to the specified virtual channel;
   (b) the “callback” parameter is an object containing a callback functions that the sever calls back the client when certain events happen on the channel.
send (message, [reliable], [dest], [callback], data)
   (a) “message” is the message to be sent (e.g., a JSON object)
   (b) “reliable” is a Boolean variable indicating whether or not the message is to be sent with guaranteed delivery.
   (c) “dest” is a parameter which, when specified, delivers the message only to the specified client, rather than to all other clients.
   (d) “call back” specifies a callback function by which the server acknowledges receipt of the message.
   (e) “data” may be any data to be interpreted by the virtual channel (e.g., shared state changes, described below)

Call back functions include:
(i) recv(message, client)
   called when a message is received on the virtual channel; the value of the “client” parameter provides the identity of the sender.
(ii) connect(channel)
   called when the connection to the virtual channel is successful.
(iii) sent(seq, jsonmessagej)
   called when a message is confirmed received by the server

Centralized communication service 102 provides message routing services for each virtual channel, so that all client programs that subscribe to the virtual channel can receive messages published on that virtual channel. As mentioned above, for applications that require a consistent serialization of messages (i.e. all messages must be seen in the same order by all clients), centralized communication service 102 can act as a messaging serializer, and a time-stamping service for the messages. For a shared state, centralized communication service 102 can maintain in its memory a variety of data structures that are synchronized (to the extent possible) for all the client programs, and which allows modification by some or all of the client programs. These structures include, but are not limited to, databases, hash tables, arrays and structured objects. For example, the database may maintain for access by all client programs a hash-map that maps a client identifier to a username. The server may make service requests for manipulating or inquiring about the shared state available to the client programs through the API in any convenient manner customary for the intended communication protocols. In one implementation, for example, the server may be a Python-based implementation.

The invention is applicable to a diverse collection of applications, such as (a) multi-player games, (b) instant messaging, (c) instant messaging embedded in web pages, collaborative document and spreadsheet editors, (d) discussion and shared synchronized browsing of pictures, diagrams, music or videos, (e) creating and accessing shared 2-d, 3-d or real virtual spaces, (f) collaborative music creation, and (g) collaborative picture art creation and multi-person audio and video conferencing. Of course, many other applications, existing or to be developed, may be possible.

The above detailed description is provided to illustrate specific embodiments of the present invention and is not intended to be limiting. Numerous variations and modifications within the scope of the present invention are possible. The present invention is set forth in the following claims.

We claim:

1. A communication service interacting with a plurality of client programs of a multi-user application that is independent of the communication service, comprising a communication handler that receives service requests from a library of programs in each client program executing on a client processor, the communication handler interacting with each client program to provide the requested service using a communication protocol over a wide area network.

2. The communication service as in claim 1, wherein the communication service further manages state information shared by the client programs.

3. The communication service as in claim 2, wherein the shared information is provided as a data structure provided as one of: one or more databases, one or more hash tables, one or more arrays or one or more other data objects.

4. The communication service as in claim 1 wherein, in response to one of the service requests from one of the client programs, the communication handler creates a virtual channel identified by name and connects the client program to the virtual channel.

5. The communication service as in claim 4 wherein, in response to one of the service requests received from another one of the client programs, in which the requesting client program requests a connection to the virtual channel, specifying the virtual channel by name, the communication handler connects the requesting client program to the virtual channel.

6. The communication service as in claim 5 wherein, in response to yet another one of the service requests, the communication handler sends one or more messages received from one of the client programs connected to the virtual channel to all of the other client programs connected to the virtual channel.

7. The communication service as in claim 6, wherein the communication handler sends the messages to each program receiving the messages under a reliable delivery protocol.

8. The communication service as in claim 5 wherein, in response to yet another one of the service requests, the communication handler passes one or more messages received from one of the client programs connected to the virtual channel to a designated one of the other client programs connected to the virtual channel.

9. A method for allowing client programs of a multi-user application program to interact using an independent communication service, comprising:
providing a library of programs to be included in each of the client programs that allow the client programs to interact with each other through the communication service using a communication protocol over a wide area network;
providing a communication handler that receives service requests from each client program through the corresponding library of programs executing on a client processor, the communication handler interacting with each client program to provided the requested service using the communication protocol.

10. The method as in claim 9, further comprising managing in the communication service state information shared by the client programs.

11. The method as in claim 10, wherein the shared information is provided as a data structure provided as one of: one or more databases, one or more hash tables, one or more arrays or one or more other data objects.

12. The method as in claim 9 further comprising, in response to one of the service requests from one of the client programs, creating in a virtual channel identified by name and connecting the client program to the virtual channel.

13. The method as in claim 12 wherein, in response to a service request specifying the virtual channel by name, connecting the client program sending the service request to the virtual channel.

14. The method as in claim 13 further comprising, in response to yet another one of the service requests, sending one or more messages received from one of the client programs connected to the virtual channel to all of the other client programs connected to the virtual channel.

15. The method as in claim 14, wherein the messages are sent to each program receiving the messages under a reliable delivery protocol.

16. The method as in claim 13 further comprising, in response to yet another one of the service requests, sending one or more messages received from one of the client programs connected to the virtual channel to a designated one of the other client programs connected to the virtual channel.

17. The method as in claim 9, wherein the library of programs are provided to a developer of the multi-user application to be integrated into the multi-user application to implement communication functions among the client programs.

18. The method as in claim 17, wherein each of the client programs is downloaded from a website maintained by the developer of the multi-user application.

19. A client program for a multi-user application communicating through a communication service that is independent of the multi-user application, comprising:
a library of programs provided by the communication service that interact with at one or more other client programs through the communication service using a communication protocol over a wide area network; and
an application portion of the client program linked to the library which calls the programs in the library to implement activities of the multi-user program that require interaction with one or more other client programs.

20. A client program as in claim 19, wherein the communication service further manages state information shared by the client program and one or more other client programs.

21. A client program as in claim 20, wherein the shared information is provided as a data structure provided as one of: one or more databases, one or more hash tables, one or more arrays or one or more other data objects.

22. A client program as in claim 19, wherein the library of programs comprise a service request to the communication service to create or subscribe to a virtual channel.

23. A client program as in claim 19, wherein the library of programs comprise a service request by one client program to send one or messages to all other client programs subscribed to the virtual channels.

24. A client program as in claim 19, wherein the library of programs comprise a service request by one client program to send one or messages to a designated one of the other client programs subscribed to the virtual channels.

25. A client program as in claim 19, wherein the client programs send to the communication service data affecting shared state information.
